(19) United States
(12) Patent Application Publication
(10) Pub. No.: US 2023/0379126 A1
(43) Pub. Date: Nov. 23, 2023

(54) METHOD, DEVICE, AND SYSTEM FOR SMALL DATA TRANSMISSION IN WIRELESS NETWORKS

(71) Applicant: ZTE Corporation, Shenzhen (CN)

(72) Inventors: Yu LIU, Shenzhen (CN); He HUANG, Shenzhen (CN)

(73) Assignee: ZTE Corporation, Shenzhen (CN)

(21) Appl. No.: 18/358,364

(22) Filed: Jul. 25, 2023

Related U.S. Application Data
(63) Continuation of application No. PCT/CN2021/083846, filed on Mar. 30, 2021.

(51) Int. Cl. H04L 5/00; H04W 74/08; H04W 72/21

(52) U.S. Cl. CPC H04L 5/0053; H04L 5/0092; H04W 74/0833; H04W 72/21

(57) ABSTRACT

This disclosure describes a method and system for small data transmission of various types. Performed by a User Equipment (UE) in a wireless network, the method including: receiving, from a base station, a first broadcast message comprising a common SDT parameter indicative of an SDT resource; initiating an SDT session using the SDT resource; and transmitting SDT data during the SDT session to the base station.

### TECHNICAL FIELD

This disclosure is directed generally to wireless communications, and particularly to a method, device, and system for small data transmission.

### BACKGROUND

A wireless network supports various types of services having different requirements for data packet transmission. These requirements include, for example, payload size, transmission latency, transmission reliability, transmission priority, and the like. When a User Equipment (UE) is in inactive or idle mode, it is critical for the UE to reduce power consumption while still being able to support data transmission with efficient radio resource utilization.

### SUMMARY

This disclosure is directed to a method, device, and system for small data transmission of various types in wireless communications.

In one embodiment, a method performed by a User Equipment (UE) in a wireless network is disclosed. The method may include receiving, from a base station, a first broadcast message comprising a common SDT parameter indicative of an SDT resource; initiating an SDT session using the SDT resource; and transmitting SDT data during the SDT session to the base station.

In another embodiment, a method for Small Data Transmission (SDT), performed by a User Equipment (UE) in a wireless network is disclosed. The method may include receiving, from a base station, a first broadcast message comprising: common SDT parameters indicative of an SDT resource; and a BWP selection indicator indicating one of: that the UE selects the SDT resource for an SDT session; and that the UE is allowed to select the SDT resource, or a general purpose resource other than the SDT resource for an SDT session; selecting a resource for the SDT session according to the BWP selection indicator; initiating the SDT session using the resource; and transmitting SDT data during the SDT session to the base station using the resource.

In another embodiment, a method for configuring SDT parameters, performed by a UE in a wireless network is disclosed. The method may include receiving, from a base station in the wireless network, a first radio resource control release (RRCRelease) message with suspend configuration, the first RRCRelease message comprising a first parameter set index, and a delta parameter, a value of the delta parameter being different compared to a value of a corresponding parameter in a first parameter set identified by the first parameter set index; and initiating an SDT session according to the first parameter set and the delta parameter.

In another embodiment, a method for configuring SDT parameters, performed by a UE in a wireless network is disclosed. The method may include configuring a UE with a configured grant parameter set for supporting SDT; determining whether the configured grant parameter set is active; and in response to the configured grant parameter set being active, prohibiting releasing the configured grant parameter set.

In another embodiment, a method for selecting an SDT type, performed by a UE in a wireless network is disclosed. The method may include determining an uplink (UL) carrier from a normal UL (NUL) and a supplementary UL (SUL) for transmitting UL data to a base station of the wireless network; and in response to determining the UL carrier, determining whether to use SDT or non SDT to transmit the UL data.

In another embodiment, a method for selecting an SDT type, performed by a UE in a wireless network is disclosed. The method may include determining whether to use SDT or non SDT to transmit UL data to a base station of the wireless network; and in response to determining of using SDT or non SDT, determining an uplink (UL) carrier from a normal UL (NUL) and a supplementary UL (SUL) for transmitting the UL data.

In another embodiment, a method for SDT, performed by a UE in a wireless network is disclosed. The method may include detecting a failure during an SDT session; and resetting an uplink counter, the uplink counter being used for security check in a subsequent RRC procedure with a base station in the wireless network.

In another embodiment, a method for SDT, performed by a UE in a wireless network is disclosed. The method may include receiving a message from a base station in the wireless network, the message comprising a dedicated search space for SDT; and receiving an SDT related Downlink Control Information (DCI) according to the dedicated search space for SDT.

In another embodiment, a method for SDT, performed by a UE in a wireless network is disclosed. The method may include initiating an SDT session via a Random Access (RA) procedure using a RA resource different from a CG resource configure for the UE to support CG-based SDT; and transmitting UL small data using the CG resource. \

In another embodiment, a method for SDT, performed by a UE in a wireless network is disclosed. The method may include receiving a message from a base station in the wireless network, the message indicating at least one of: a dedicated DL BWP for supporting SDT; a dedicated UL BWP for supporting SDT; or SDT related parameters; and transmitting a service request during an SDT session according to the message

In some embodiments, there is a wireless communication device comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example wireless communication network.

FIG. 2 shows an example small data transmission (SDT) procedure with error recovery.

FIG. 3 shows example multiple step random access procedures.

FIG. 4 shows an example SDT Bandwidth Part (BWP).

### DETAILED DESCRIPTION

### Wireless Communication Network

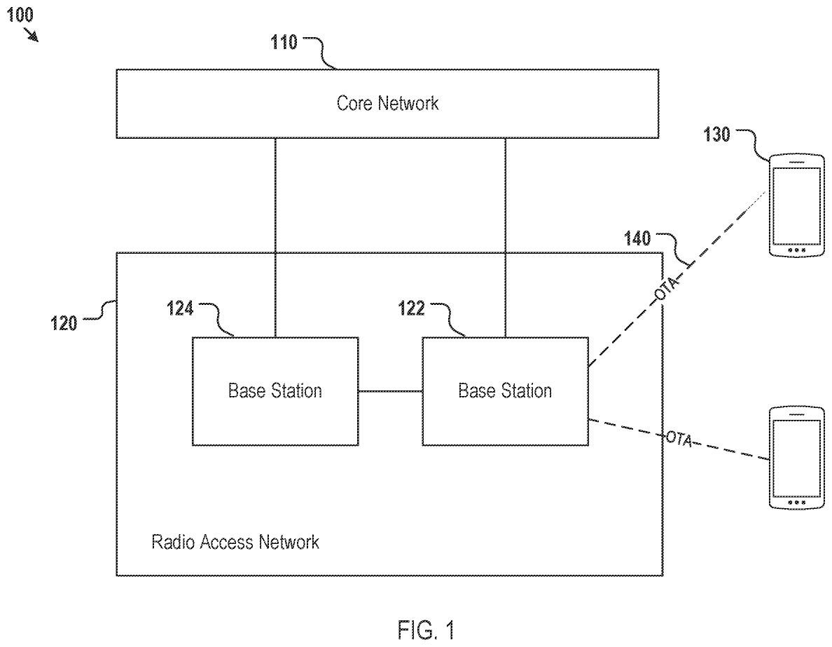

FIG. 1 shows an example cellular wireless communication network 100 (also referred to as wireless communication system) that includes a core network 110 and a radio access network (RAN) 120. The RAN 120 further includes multiple base stations 122 and 124. The base station 122 and user equipment (UE) 130 communicate with one another via Over the Air (OTA) radio communication resources 140. The wireless communication network 100 may be implemented as, as for example, a 2G, 3G, 4G/LTE, or 5G cellular communication network. Correspondingly, the base stations 122 and 124 may be implemented as a 2G base station, a 3G nodeB, an LTE eNB, or a 5G New Radio (NR) gNB. The UE 130 may be implemented as mobile or fixed communication devices installed with SIM/USIM modules for accessing the wireless communication network 100. The UE 130 may include but is not limited to mobile phones, Internet of Things (IoT) devices, Machine-type communications (MTC) devices, laptop computers, tablets, personal digital assistants, wearable devices, distributed remote sensor devices, roadside assistant equipment, and desktop computers. Alternative to the context of cellular wireless network, the RAN 120 and the principles described below may be implemented as other types of radio access networks, such as Wi-Fi, Bluetooth, ZigBee, and WiMax networks.

In the example wireless communication system 100 of FIG. 1 the UE 130 may connect with and establish a communication session with the base station 122 via the OTA interface 140. The communication session between the UE 130 and the base station 122 may utilize downlink (DL) and/or uplink (UL) transmission resources. The DL transmission resource carries data from the base station 122 to the UE 130, and the UL transmission resource carries data from the UE 130 to the base station 122.

### Small Data Transmission

In the wireless communication network, a user equipment (UE) may communicate in a small data transmission (SDT) mode. In legacy implementations, the transmission of user data is not allowed when in an inactive state. Even for the transmission of a very small amount of data, the UE needs transition to a connected state first, which may have a negative impact on system efficiency as a result of relatively heavy signaling overhead as well as device energy consumption. As described in the various implementations below, the transmission of small data payloads may be made instead in an inactive state of the UE. Under the prescription of the current new radio (NR) specifications, the UE may have three operational states: idle, inactive and connected. The UE cannot transmit data in idle and inactive states. When the UE needs to transmit data when it is in the idle or inactive state, the UE would first transition to the connected state. As described in the various example implementations below, for small data transmission (SDT), the UE may be configured to transmit small data in an inactive state, rather than having to transitioning to the connected state first.

Any device that has intermittent small data packets for transmission in an inactive state can benefit from the schemes described below for small data transmission (SDT) while in an inactive state. SDT traffic may have different service requirements as compared to that of conventional or larger data transmission types. SDT communication or data transfer may be made from/to the UE while in an inactive state. The UE may send an SDT request message to a base station, which may be, for example, a nodeB (e.g., an eNB or gNB) in a cellular mobile telecommunications context. The base station may respond to the UE request message with a reply that includes an SDT indication or acknowledgement. The SDT indication signals the UE that communication may be made from the UE even in an inactive state. Schemes of small data transmissions while in an inactive state facilitates reduction of power consumption and overall signaling overhead.

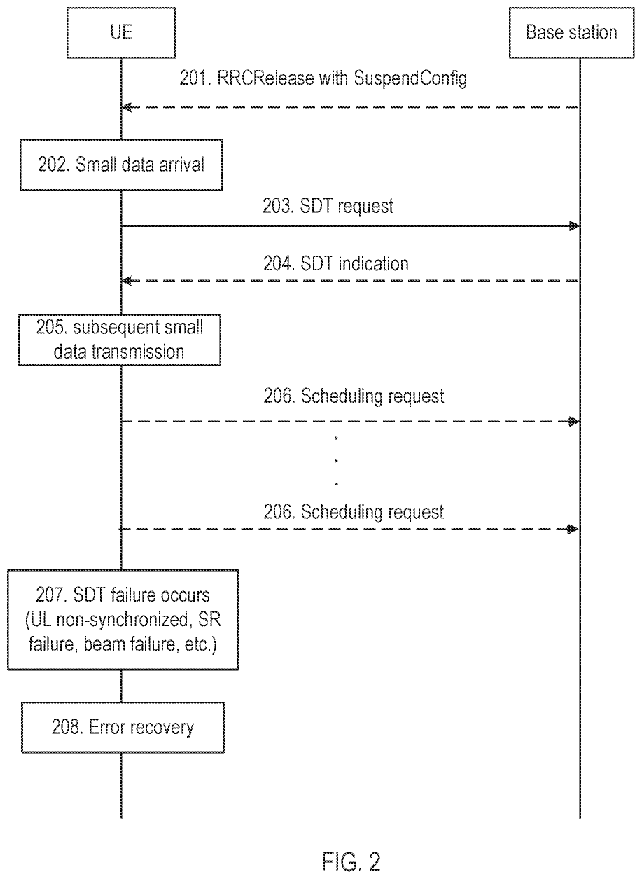

FIG. 2 shows an example small data transmission (SDT) procedure for a UE in an inactive state. FIG. 2 illustrates communication between the UE and a base station such as a gNB. As an example precondition, the UE transitions to inactive state in 201 upon receiving an RRCRelease message with SuspendConfig. As shown in 202, small data may arrives at the UE in the inactive state, which triggers the UE to initiate an SDT communication session (alternatively referred to as SDT session) by sending an SDT request to the base station at 203. This step may be referred to as the SDT initiation step. The initiation step may be performed by using a Random Access (RA) procedure, or by using dedicated resource such as Configured Grant (CG) resource. The base station may acknowledge the SDT request at 204, and the SDT session may then be established. At step 205, the SDT session is considered to be established successfully and UE is ready for small data transmission. At step 206, the UE requests uplink (UL) resource by sending a scheduling request (SR) to the base station. The UL resource is used for subsequent UL data transmission. Based on the payload size, the UE may need to send multiple scheduling requests to acquire multiple UL resources. Alternatively, not shown in FIG. 2, rather than being requested by the UE, the UL resource may be preconfigured, for example, by the base station. For example, the base station may schedule a periodic UL resource allocation for the UE. If the UL resource is preconfigured, there would be no need for the UE to send the scheduling request.

Various different example mechanisms may be implemented for the UE to send the SDT request to the base station in step 203. The difference between the various mechanisms may include communication resource that the UE uses to send the SDT request to the base station. In one example scheme, when the UE is triggered to enter the inactive state by the RRCRelease message in step 201, the RRCRelease message may carry a preconfigured resource that the UE may use to send the SDT request. This scheme is referred to as a Configured Grant scheme (hereinafter called CG-scheme). An SDT session initiated by the CG-scheme may be referred to as a CG-based SDT or a CG-SDT. In another scheme, rather than using a preconfigured resource, the UE uses common resource, such as a Random Access Channel (RACH) resource to send the SDT request. This scheme is referred to as a RACH scheme (hereinafter called RACH-scheme, or RA-scheme). An SDT session initiated by the RA-scheme may be referred to as a RA-based SDT or RA-SDT.

In the subsequent small data transmission, the UE may or may not need to send an SDT scheduling request. In some embodiments, if the SDT session is CG-based, then scheduling request for subsequent small data transmission may be required. In some embodiments, if the SDT session is RACH-based, preconfigured resource may be used for small data transmission without scheduling request.

Referring further to FIG. 2, the SDT session may encounter failure conditions 207 at various stages of the SDT session. The failure may be caused by poor signal coverage, resource limitation, and the like. Accordingly, the failure may be of various type. For example, there may be synchronization failure during the SDT session. Specifically, the synchronization between the UE and the base station may get lost (i.e., out of synchronization) during the SDT session, which may be indicated by a Timing Alignment (TA) timer expiration. For another example, there may be scheduling request failure. Such a scheduling request failure may impact subsequent small data transmission. For yet another example, a beam failure condition may occur. In presence any of these failure conditions, the UE may perform error recovery action 208. In this disclosure below, one embodiments are described for recovering from the aforementioned failure conditions. For example, in some implementations, an uplink counter may be reset by the UE to keep the UE and the network in synchronization with respect to the uplink counter, which is critical for subsequent procedures.

As described above and in more detail below, the various embodiments provide flexible and efficient resource allocation to a UE for supporting SDT. The various embodiments further improve on several other aspects of small data transmission, including but not limited to SDT type selection, error recovery, and uplink data transmission.

### Random Access Procedure

As described above, a random access (RA) procedure may be utilized during an SDT session. For example, the UE may use the RA procedure to initiate an SDT session.

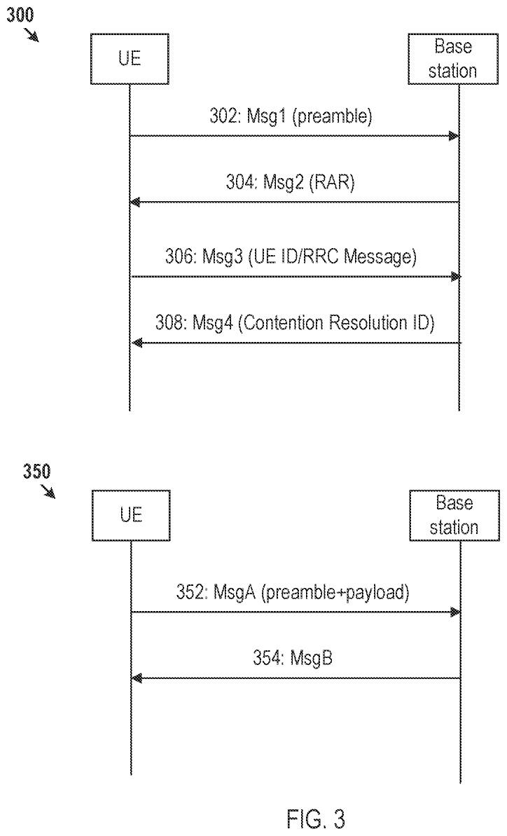

FIG. 3 shows example multi-step random access procedures 300 and 350. In various implementations, a UE and base station may engage in a multi-step protocol, where: (i) the UE send a preamble (e.g., in Msg1) to the base station (302), (ii) after reception of preamble, the base station sends back a random access response (RAR) (e.g., Msg2) to the UE (304), (iii) the UE sends to the base station a third message (e.g., Msg3) according to the UL grant indicated in the RAR containing the preamble transmitted in Msg1 (306), and (iv) after successfully decoding Msg3, a fourth message (e.g., Msg4) is transmitted from the base station to the UE for performing contention resolution (308). This example four-step random access channel (RACH) procedure 300 (alternatively referred to as 4-step RACH) may allow for establishment of RRC connections.

In some implementations, the latency created through the 4-step RACH procedure 300 may be reduced by using a two-step random access protocol 350 (alternatively referred to as a 2-step RACH). The 2-step RACH 350 may combine (i) and (iii) and combine (ii) and (iv) of the 4-step RACH procedure to condense the RACH procedure into two steps. The first step is to send a first message, e.g. MsgA (352). In some examples the first message may contain a preamble transmitted in physical random access channel and/or payload transmitted in physical uplink shared channel, which contains at least the same amount of information that is carried in Msg3 of 4-step RACH. A second message, e.g. MsgB in respond to MsgA is transmitted from the base station to the UE (354). The example 2-step RACH may help reduce communication latency compared to the 4-step RACH. Such a reduction of communication latency may further help, for example reduce channel occupancy times and increase data available for payload transmission. Accordingly, the 2-step RACH provides a technical solution to a network latency and other technical problem by increasing data network performance and improving the operation of network underlying hardware.

The 2-step and 4-step RACH described above may be contention based. In some other implementations, the base station informs the UE a preamble index to use for the random access, leading to a contention free RACH procedure.

In this disclosure, an SDT session based on 2-step RACH as described above is also referred to as a 2-step RA-SDT; an SDT session based on 4-step RACH as described above is also referred to as a 4-step RA-SDT.

In some implementations, the UE may choose to use different RACH resource to initiate the random access procedure

### RA-SDT Parameter Configuration

For an RA-based SDT, the UE uses Random Access (RA) resource to initiate the SDT session. In some embodiments, multiple RA resources may be configured for the UE. For example, one RA resource may be configured in the initial Bandwidth Part (BWP) of the UE and another RA resource may be configured in another BWP different from the initial BWP. The initial BWP, on one hand, may be considered as a general purpose BWP, as it serves various UE tasks, such as initial cell access, as well as SDT tasks. The other BWP, on the other hand, may be configured to serve special purpose, for example, to be dedicated for SDT tasks.

Since UEs use the initial BWP to perform initial access to the cell, to ensure the successful rate of cell access and to meet the requirement for supporting a specific access amount, the initial BWP resource needs to be allocated efficiently and provides enough capacity to support UE's cell access activities. It is beneficial to allocate an SDT BWP resource which is dedicated for supporting SDT sessions, and the UE may be configured to utilize the SDT BWP to perform SDT related tasks rather than compete for the initial BWP resource.

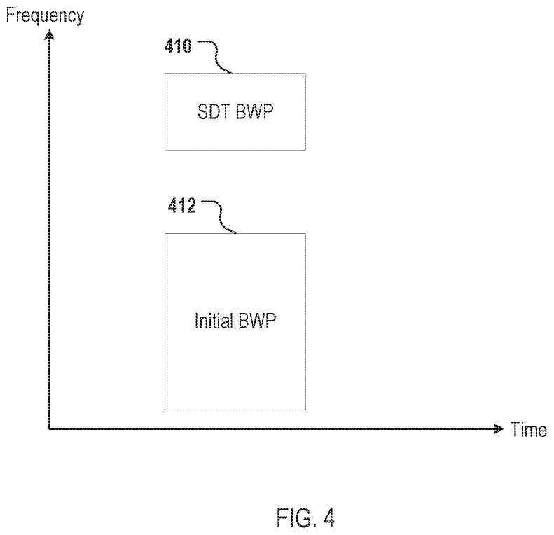

In some embodiments, as shown in FIG. 4, the network (e.g., base station) may configure an SDT BWP 410. The network may broadcast the SDT parameters for the SDT BWP via System Information (SI) such as System Information Block-1 (SIB1). The SDT parameters include BWP-specific parameters and other SDT related parameters. In some embodiments, the frequency domain resource of the SDT BWP has no overlap with the initial BWP 412. In some embodiments, at least partial of the frequency domain resource of the SDT BWP does not overlap with the initial BWP.

In some embodiments, after the network configure the SDT BWP, the network is further able to update the SDT BWP dynamically, for example, based on network load condition. The network may update the frequency domain resource allocated for the SDT BWP. The network may also update other parameters for the SDT BWP. The update may be carried through broadcast message such as System Information. The UE, even in an SDT session, may be configured to receive and apply the update from broadcast message, therefore the UE is able to use the updated SDT BWP for subsequent SDT tasks.

In some embodiments, the network may choose a static approach in which the UE always uses the SDT BWP for SDT tasks.

In some embodiments, the network may choose a dynamic approach in which how the UE choose the resource may be further configured. The traffic load in a network may follow certain characteristics and may change from time to time. For example, during peak hour, more UEs may attempt to initiate cell access, so the initial BWP may be heavily loaded. Whereas during off peak hour, less UEs may attempt to initiate cell access, so there may be resource available in the initial BWP. The network may broadcast a BWP indicator to instruct the UE how to choose the BWP for SDT tasks. For example, the indicator may indicate that the UE can only use the SDT BWP for SDT tasks; or the UE can choose either the SDT BWP or the initial BWP for SDT tasks, and this may be up to UE's implementation. Furthermore, the BWP indicator may be broadcast together with other SDT parameters when configuring the SDT BWP, or the BWP indicator may be broadcast separately.

Network may determine the SDT indicator according to the current load condition. For example, by a ratio of UEs performing SDT tasks and UEs not performing SDT tasks, or a ratio of UEs performing SDT tasks and UEs not performing SDT tasks during a predetermine period. The network may update the SDT indicator when the load condition changes.

The aforementioned SDT parameters are transmitted to the UE in a broadcast manner. These broadcast SDT parameters may be considered as common SDT parameters, as all the UEs listen to the broadcast message may share these SDT parameters.

In addition to common SDT parameters, there may be dedicated SDT parameters, in the sense that this type of SDT parameters are sent to the UE via dedicated messages. In some embodiments, the UE may perform SDT tasks based on both common SDT parameters and dedicated SDT parameters. For example, the UE may initiate the SDT session according to common SDT parameters. After the SDT session is established, the UE may perform subsequent small data transmission according to dedicated SDT parameters. The network may be able to reconfigure dedicated SDT parameters via RRC signaling during subsequent small data transmission phase. The UE may release or suspend these dedicated SDT parameters when the UE ends the SDT session. In some implementations, the network may use msgB or msg4 as described above to instruct the UE to choose between one of the initial BWP and the SDT BWP for subsequent small data transmission during an SDT session.

### CG-SDT Parameter Configuration

In this disclosure, in order to support flexible and efficient CG-SDT parameter configuration, various embodiments are disclosed below.

### Option 1

For the CG-SDT, in some embodiments, The UE may be initially configured with a set of dedicated SDT parameters when the UE transitions to an inactive or idle state, via RRC signaling (such as RRCRelease with suspendConfig). Afterwards, the UE may be configured with delta parameters based on the previous configured set of dedicated SDT parameters.

### Option 2

In some embodiments, when the UE is in connected state, the UE may be configured with at least one set of Configured Grant (CG) parameters. The CG parameters may be related to configured grant resources and may include SDT CG related parameters along with other parameters. Each set of the CG parameters may be associated with a CG parameter set index. When the UE transitions to an inactive or idle state, the UE needs to be configured with SDT CG parameters. In this case, the CG parameter set configured in the UE may already include the particular SDT CG parameter(s). For example, the network needs to configure SDT CG parameter A and B with the UE. On the UE side, A and B may already be configured in a CG parameter set when the UE is in connected state. For example, in the CG parameter set, A is set to a same value as the desired value of SDT CG parameter A while B is set to a different value compared with the desired value of SDT CG parameter B. In this case, when the network configure the SDT CG parameters, instead of sending to the UE the full set of SDT CG parameters, the network may choose to only send a delta parameter, which has a value that need to be updated based on the already configured CG parameter set. The network may send the delta parameter together with a CG parameter set index. Once the UE receives the delta parameter, the UE may use the delta parameter to update the CG parameter set identified by the CG parameter set index. Using the above example, the network only needs to send a delta parameter B together with the CG parameter set index. As only delta parameters need to be transmitted to the UE, the message size is reduced thus the signaling efficiency is improved.

### Option 3

In some embodiment, option 1 and option 2 in this section may be combined. That is, when the UE transitions to an idle or an inactive state, the network may send a complete set of SDT CG parameters to the UE via RRC signaling (such as RRCRelease with suspendConfig). The network may also send a “delta update” as described in option 2, to update an existing CG parameter set configured when the UE is in connected state. The details may be found from option 1 and option 2 above, and are not described herein.

### CG Configuration Restriction

### Option 1

The network is not allowed to reconfigure or release an SDT CG parameter set when the SDT CG parameter set is active.

### Option 2

The network is not allowed to release an SDT CG parameter set when the SDT CG parameter set is active. However, the network is allowed to reconfigure an SDT CG parameter set at any time no matter the SDT CG parameter set is active or not.

In some embodiments, the SDT CG parameter set is active when it is associated with the active BWP selected by the UE during an SDT session.

In some embodiments, the SDT CG parameter set is active when it is associated with the active BWP selected by the UE during an SDT session, and the Reference Signal Received Power (RSRP) of Synchronization Signal Block (SSB) associated with the SDT CG parameters set is above the a predetermined SDT CG selection threshold.

In some embodiments, the UE may be configured with multi-BWPs for supporting CG SDT. Specifically, each BWP may be associated with a CG SDT parameter set. During a CG-SDT session, these BWPs may be dynamically allocated to the UE via Downlink Control Information (DCI) or RRC signaling, so the UE may switch the BWP in the middle of a CG-SDT session.

### SDT Type Selection—Method 1

When there is Uplink (UL) data needs to be transmitted to the network, not only the UE needs to determine whether to use SDT or non SDT, the UE also needs to further select an SDT type if SDT is selected. For example, the SDT may be RA-SDT or CG-SDT. If the RA-SDT is selected, a further selection is needed to select 2-step RA-SDT or 4-step RA-SDT.

Steps for SDT type selection using various thresholds are described in this section. In this disclosure, some new thresholds are introduced for assisting SDT type selection.

### SDT and Non SDT Selection Threshold

In a wireless network, the radio signal quality in cell edge is generally bad compared with a location closer to the cell center. An SDT session initiated from cell edge faces more challenges due to poor signal quality. In order to improve the SDT success rate, a new threshold (e.g., RSRP-Threshold-SDT) for determining whether to use SDT or non SDT is introduced in this embodiment. UE can initiate SDT only if the RSRP of the downlink pathloss reference is above this threshold ‘RSRP-Threshold-SDT’. In some embodiments, this threshold applies to both NUL and SUL carrier. In some embodiments, this threshold may be separately configured for NUL and SUL (i.e., each of the NUL and the SUL has a corresponding RSRP-Threshold-SDT). The RSRP of the downlink pathloss reference is for exemplary purpose, other references may be chosen based on a practical need.

### RA Type Selection Threshold

RA-SDT includes 2-step RA-SDT and 4-step RA-SDT, and RA-SDT parameters can be configured in NUL carrier and SUL carrier. When UE initiates RA-SDT, UE needs to select a RA type. An RA type selection threshold (e.g., msgA-RSRP-Threshold-SDT) is introduced, which may be configured with a value bigger than the msgA-RSRP-Threshold. The msgA-RSRP-Threshold is a threshold for general random access procedure which may not be configured based on SDT or with SDT in mind. Specifically, this RA type selection threshold may be separately configured in NUL carrier and SUL carrier.

In some embodiments, the UE selects an uplink carrier first before making other further selections. The detailed steps for choosing an SDT type based on the above thresholds are described below.

### Step 1: NUL and SUL Selection

When the UE is in inactive or idle state, if the UE needs to transmit UL data associated with an SDT Data Radio Bearer (DRB), the UE first determines whether to select an NUL carrier or an SUL carrier.

If the RSRP of the downlink pathloss reference is below a first predetermined threshold (e.g., rsrp-ThresholdSSB-SUL), the UE selects the SUL; otherwise the UE selects the NUL.

### Step 2: SDT and Non SDT Selection

After the UE selects either the NUL or the SUL as the uplink carrier, the UE determines whether to use SDT to transmit the UL data, or to use non SDT.

The UE selects to use SDT if all the following conditions are met:
the serving cell of the UE supports SDT;
the size of the UL data is less than a data size threshold configured by the base station;
the UL data is not associated with a non-SDT DRB; and
the RSRP of the downlink pathloss reference is above a second predetermined threshold (e.g., RSRP-Threshold-SDT).

If any condition above is not met, the UE selects non SDT.

### Step 3: CG-SDT and RA-SDT Selection

In step 2, if the UE determines to use SDT for uplink data transmission, the UE proceeds to determine whether the SDT needs to be CG based or RA based.

The UE may be configured with multiple CG SDT parameter sets. For example, there may be CG SDT parameter sets configured for NUL and SUL, respectively.

### Step 3.1:

If the UE selects NUL in step1, and CG-SDT (e.g., CG SDT parameter set) is configured and valid in NUL, the UE selects CG-SDT configured in NUL.

### Step 3.2:

If the UE selects SUL in step1, and CG-SDT is configured and valid in SUL, the UE selects CG-SDT configured in SUL.

### Step 3.3:

If the UE selects NUL in step1, however CG-SDT is only configured and valid in SUL and there is no valid CG-SDT configured in NUL, then the UE needs to reselect SUL as the uplink carrier and then selects CG-SDT configured in SUL.

### Step 3.4:

If the UE is not able to select a CG-SDT from either NUL or SUL, for example, due to there is no valid CG-SDT configured for the selected uplink carrier, then the UE selects RA-SDT.

### Step 4: 2-Step RA-SDT and 4-Step RA-SDT Selection

If the UE selects RA-SDT in step 3, the UE needs to further determine whether to use a 2-step RA-SDT or a 4-step RA-SDT.

If 2-step random access is configured in the selected UL carrier, and the RSRP of the downlink pathloss reference is above a third predetermined threshold (e.g., msgA-RSRP-Threshold-SDT), the UE selects the 2-step RA-SDT; otherwise the UE selects the 4-step RA-SDT.

### SDT Type Selection—Method 2

Method 2 discloses another approach for SDT type selection. In this disclosure, some new thresholds are introduced for assisting SDT type selection.

### SDT and Non SDT Selection Threshold

In a wireless network, the radio signal quality in cell edge is generally bad compared with a location closer to the cell center. An SDT session initiated from cell edge faces more challenges. In order to improve the SDT success rate, a new threshold (e.g., RSRP-Threshold-SDT) for determining whether to use SDT or non SDT is introduced in this embodiment. UE can initiate SDT only if the RSRP of the downlink pathloss reference is above this threshold RSRP-Threshold-SDT′. In some embodiments, this threshold applies to both NUL and SUL carrier. In some embodiments, this threshold may be separately configured for NUL and SUL (i.e., each of the NUL and the SUL has a corresponding RSRP-Threshold-SDT).

In some embodiments, UE is only configured with NUL carrier, and the threshold RSRP-Threshold-SDT is configured in the NUL. In this case, the UE uses RSRP-Threshold-SDT configured in the NUL for SDT or non SDT selection.

In some embodiments, UE is configured with both NUL and SUL carriers, and the threshold RSRP-Threshold-SDT is only configured in the SUL. In this case, the UE uses RSRP-Threshold-SDT configured in the SUL for SDT or non SDT selection.

In some embodiments, UE is configured with NUL and SUL carrier, the threshold RSRP-Threshold-SDT is separately configured in NUL and SUL carriers. In this case, the UE uses min{RSRP-Threshold-SDT configured in NUL, RSRP-Threshold-SDT configured in SUL} for SDT or non SDT selection, where “min” is the operation for selecting the minimum value in the parameter set.

### NUL and SUL Selection Threshold

In an SDT session, the UE may transmit small data can together with msg3. In order to improve the small data transmission success rate in the NUL carrier, a NUL and SUL selection threshold (e.g., RSRP-Threshold-SUL-SDT) is introduced. This threshold may be configured with a value bigger than the rsrp-ThresholdSSB-SUL threshold. The rsrp-ThresholdSSB-SUL threshold is a threshold for general random access procedure which may not be configured based on SDT.

### RA Type Selection Threshold

RA-SDT includes 2-step RA-SDT and 4-step RA-SDT. RA-SDT parameters can be configured in NUL carrier and SUL carrier. When UE initiates RA-SDT, UE needs to select a RA type. An RA type selection threshold (e.g., msgA-RSRP-Threshold-SDT) is introduced, which may configured with a value bigger than the msgA-RSRP-Threshold. The msgA-RSRP-Threshold threshold is a threshold for general random access procedure which may not be configured based on SDT. Specifically, this threshold may be separately configured in NUL carrier and SUL carrier.

In some embodiment, the UE first selects whether to use SDT or non SDT to transmit UL data. The detailed steps for choosing an SDT type based on the above thresholds are described below.

### Step 1: SDT and Non SDT Selection

When the UE is in inactive or idle state, if the UE needs to transmit UL data associated with an SDT Data Radio Bearer (DRB), the UE first determines whether to select SDT or Non SDT for the uplink data transmission.

The UE selects to use SDT if all the following conditions are met:
the serving cell of the UE supports SDT;
the size of the UL data is less than a data size threshold configured by the base station;
the UL data is not associated with a non-SDT DRB; and
the RSRP of the downlink pathloss reference is above a first predetermined threshold (e.g., RSRP-Threshold-SDT).

If any condition above is not met, then the UE selects non SDT.

### Step 2: NUL and SUL Selection

If the UE selects SDT in step 1, the UE further determines whether to select an NUL carrier or an SUL carrier.

If the RSRP of the downlink pathloss reference is below a second predetermined threshold (e.g., RSRP-Threshold-SUL-SDT), the UE selects the SUL; otherwise the UE selects the NUL.

### Step 3: CG-SDT and RA-SDT Selection

In step 2, if the UE determines to use SDT for uplink data transmission, the UE proceeds to determine whether the SDT needs to be CG based or RA based.

The UE may be configured with multiple CG SDT parameter sets. For example, there may be CG SDT parameter sets configured for NUL and SUL, respectively.

### Step 3.1:

If the UE selects NUL in step1, and CG-SDT is configured and valid in NUL, the UE selects CG-SDT configured in NUL.

### Step 3.2:

If the UE selects SUL in step1, and CG-SDT is configured and valid in SUL, the UE selects CG-SDT configured in SUL.

### Step 3.3:

If the UE selects NUL in step1, however CG-SDT is only configured and valid in SUL and there is no valid CG-SDT configured in NUL, then the UE needs to reselect SUL as the uplink carrier and selects CG-SDT configured in SUL.

### Step 3.4:

If the UE is not able to select a CG-SDT from either NUL or SUL, for example, due to there is no valid CG-SDT configured for the selected uplink carrier, then the UE selects RA-SDT.

### Step 4: 2-Step RA-SDT and 4-Step RA-SDT Selection

If the UE selects RA-SDT in step 3, the UE needs to further determine whether to use a 2-step RA-SDT or a 4-step RA-SDT.

If 2-step random access is configured in the selected UL carrier, and the RSRP of the downlink pathloss reference is above a third predetermined threshold (e.g., msgA-RSRP-Threshold-SDT), the UE selects the 2-step RA-SDT; otherwise the UE selects the 4-step RA-SDT.

### SDT Fallback

For an SDT session, whether it is RA based on CG based, the UE may experience failure during the SDT session. For example, the UE does not receive any DL data after multiple retransmission of the SDT request message during SDT initiation phase. If such failure happens, the UE may need to fallback to RRC resume procedure.

In some embodiments, the UE transitions to an idle state and performs cell selection to recover from the error condition.

In some embodiments, the UE performs Radio Resource Control (RRC) re-establishment procedure. Specifically, the UE and the network each maintains an uplink counter for synchronization purpose. If there is an error during the SDT session, the UE may increment the uplink counter whereas the corresponding uplink counter is not incremented on the network side which causes the uplink counter to be out of synchronization. As the uplink counter is used for security check in a subsequent RRC re-establishment procedure, the inconsistency of the uplink counter may cause a failure in the RRC re-establishment procedure. Therefore, the UE resets the uplink counter before invoking the re-establishment procedure, so the uplink counter is back in synchronization with the network.

### SDT Data Transmission

In this disclosure, various embodiments are disclosed to support SDT data transmission after the SDT session is successfully established (i.e., initiated).

For RA-SDT, there are two options to schedule downlink data.

### Option 1

The network may configure some RA SDT parameters for supporting SDT. These parameters include a RA search space for SDT, and Physical Downlink Shared Channel (PDSCH) configuration parameters for SDT. The network may broadcast these RA SDT parameters via broadcast message such as System Information message.

### Option 2

The network may configure a new SDT search space to support SDT related DCI reception.

For RA-SDT, there are four options to schedule uplink data.

### Option 1

If there is uplink small data needs to be transmitted, or if there is pending Buffer Status Report (BSR) pending, the UE needs to acquire uplink resource. If there is no UL grant to the UE, the UE triggers an RA procedure to request UL grant.

### Option 2

The UE is configured with CG-SDT resources. Due to certain reasons (e.g., the UE does not have a valid Timing Alignment), the UE has to initiate an SDT session based on an RA procedure using the RA-SDT resource. Once the RA procedure is completed successfully, the UE re-gains UL time synchronization and a valid beam. Therefore, the UE may switch back from the RA-SDT resource to the CG-SDT resource. The selected CG-SDT resource is associated with the beam selected by the RA procedure. The UE then transmits subsequent UL small data using the selected CG-SDT resource.

### Option 3

The network may configure dedicated resources, such as dedicated downlink BWP, dedicated uplink BWP, and other Scheduling Request (SR) related parameters (for sending SR) to the UE via msg4 or msgB. Based on these resources and the SR related parameters, the UE may send SR to request UL grant upon subsequent UL small data arrival.

### Option 4

The network may automatically schedule a UL DCI periodically based on a predefined periodicity, using RA-SDT common resources (such as RA search space or SDT specific search space). The predefined periodicity may be configured by OAM. In this option, since the UL resource is granted automatically, the UE does not need to use RA procedure or SR to request UL grant.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method for Small Data Transmission (SDT), performed by a User Equipment (UE) in a wireless network, comprising:
receiving, from a base station, a first broadcast message comprising a common SDT parameter indicative of an SDT resource;
initiating an SDT session using the SDT resource; and
transmitting SDT data during the SDT session to the base station.

2. The method of claim 1, wherein the SDT resource comprises an SDT Bandwidth Part (BWP) dedicated for supporting SDT.

3. The method of claim 2, wherein the SDT BWP comprises a frequency domain resource separated from a frequency domain resource of an initial BWP allocated to the UE.

4. The method of claim 1, wherein transmitting the SDT data to the base station comprises:
transmitting the SDT data to the base station using the SDT resource.

5. (canceled)

6. The method of claim 1, wherein the SDT session comprises a Random Access based (RA-based) SDT session.

7. The method of claim 1, wherein the first broadcast message comprises a System Information.

8-20. (canceled)

21. A method for selecting an SDT type, performed by a UE in a wireless network, comprising:
determining an uplink (UL) carrier from a normal UL (NUL) and a supplementary UL (SUL) for transmitting UL data to a base station of the wireless network; and
in response to determining the UL carrier, determining whether to use SDT or non SDT to transmit the UL data.

22. The method of claim 21, wherein determining the UL carrier comprises:
in response to a signal reference being below a first predetermined threshold, selecting the SUL, otherwise selecting the NUL.

23. The method of claim 22, wherein determining whether to use SDT or non SDT to transmit the UL data comprises:
in response to:
a serving cell of the UE supporting SDT;
a size of the UL data being less than a data size threshold configured by the base station;
the UL data being not associated with a non-SDT Data Radio Bearer (DRB); and
the signal reference being above a second predetermined threshold,
determining to use SDT to transmit the UL data, otherwise determining to use non SDT to transmit the UL data.

24. The method of claim 23, further comprising:
determining whether to use a CG-based SDT or an RA-based SDT; and
in response to the RA-based SDT being selected, determining whether to use a 2-step Random Access (RA) procedure or a 4-step RA procedure.

25. (canceled)

26. The method of claim 24, wherein the CG-based SDT has a higher priority than the RA-based SDT.

27. The method of claim 24, wherein in response to the RA-based SDT being selected, determining whether to use the 2-step RA procedure or the 4-step RA procedure comprises:
in response to the signal reference being above a third predetermined threshold, selecting the 2-step RA procedure, otherwise selecting the 4-step RA procedure.

28. The method of claim 22, wherein the signal reference comprises a Reference Signal Received Power (RSRP) of a downlink pathloss reference.

29-38. (canceled)

39. A method for SDT, performed by a User Equipment (UE) in a wireless network, the method comprising:
receiving a message from a base station in the wireless network, the message comprising a dedicated search space for SDT; and
receiving an SDT related Downlink Control Information (DCI) according to the dedicated search space for SDT.

40. The method of claim 39, wherein the message comprises a System Information (SI), and wherein the SDT comprises an RA-based SDT.

41-46. (canceled)

47. The method of claim 1, further comprising:
in response to an error or a failure in the SDT session, transitioning to an idle state, and performing a cell selection procedure, to recover from the error or the failure in the SDT session.

48. The method of claim 1, further comprising:
in response to that there is uplink small data needs to be transmitted, or in response to that there is pending Buffer Status Report (BSR), attempting to acquire uplink resource; and
in response to no uplink resource being granted after attempting to acquire the uplink resource, triggering a Random Access (RA) procedure to request uplink resource grant.

49. A wireless terminal comprising a memory for storing computer instructions and a processor in communication with the memory, wherein the processor, when executing the computer instructions, is configured to implement a method of claim 1.

50. A wireless terminal comprising a memory for storing computer instructions and a processor in communication with the memory, wherein the processor, when executing the computer instructions, is configured to implement a method of claim 21.

51. A wireless terminal comprising a memory for storing computer instructions and a processor in communication with the memory, wherein the processor, when executing the computer instructions, is configured to implement a method of claim 39.
